(19) United States
(12) Patent Application Publication
(10) Pub. No.: US 2025/0043041 A1
(43) Pub. Date: Feb. 6, 2025

(54) FUNCTIONALIZED DIENE RUBBERS PREPARED WITH UNSATURATED SILOXANE-BASED COUPLING AGENTS

(71) Applicant: ARLANXEO DEUTSCHLAND GMBH, Dormagen (DE)

(72) Inventors: Benjamin GUTSCHANK, Dormagen (DE); Kilian Nikolaus Richard WUEST, Dormagen (DE); Norbert STEINHAUSER, Dormagen (DE)

(73) Assignee: ARLANXEO DEUTSCHLAND GMBH, Dormagen (DE)

(21) Appl. No.: 18/717,405

(22) PCT Filed: Dec. 6, 2022
(86) PCT No.: PCT/EP2022/084575

§ 371 Date: Jun. 6, 2024

(30) Foreign Application Priority Data
Dec. 7, 2021 (EP) 21212860.7

(51) Int. Cl. C08F 8/42; B60C 1/00; B60C 11/00; C08G 77/442

(52) U.S. Cl. CPC C08F 8/42; B60C 1/0016; B60C 11/0008; C08G 77/442; B60C 2011/0025

(57) ABSTRACT

Method of making a polydiene rubber comprising
(i) polymerizing at least one aliphatic conjugated diene monomer, preferably having from 4 to 25 carbon atoms, to produce a polymer having reactive polymer chain ends,
(ii) reacting at least some of the reactive polymer chain ends with a coupling agent comprising from 2 to 20 unsaturated siloxane units, preferably from 3 to 15 units, more preferably from 3 to 10 units,
(iii) using at least one functionalization agent for introducing at least one functional group to the polymer, wherein the functional group, preferably, has in addition to C and H atoms at least one heteroatom selected from Si, S, N, O or combinations thereof and wherein (iii) is carried out before, after or during step (ii).

Also provided are polydiene rubbers obtained by the method, curable compositions comprising the polydiene rubber and composition comprising the cured polydiene rubber.

### BACKGROUND

Diene rubbers are widely used as a raw material for producing tires. Coupling agents may be used for improving diene rubber processing. Coupling agents link the polymer chains of the rubbers with each other to create a branched or star-shaped polymer architecture. This leads to a broader molecular weight distribution of the polymers and reduces the Mooney viscosity of compounds containing them and facilitates their processing. Examples of known coupling reagents include silicon tetrachloride, methyltrichlorosilane, dimethyldichlorosilane, tin tetrachloride, dibutyltin dichloride, tetraalkoxysilanes, derivatives of ethylene glycol diglycidyl ether, 1,2,4-tris(chloromethyl)benzene. In US2005/0107541A1 the use of a substituted silasesquioxane, a polycyclic substituted polysiloxane, as a coupling agent is reported. However, it has been found that polymer properties can be improved by using certain coupling agents in combination with additional functionalizing agents.

### SUMMARY

Therefore, in one aspect there is provided a method of making a polydiene rubber comprising
(i) polymerizing at least one aliphatic conjugated diene monomer, preferably having from 4 to 25 carbon atoms, to produce a polymer having reactive polymer chain ends,
(ii) reacting at least some of the reactive polymer chain ends with a coupling agent comprising from 2 to 20 unsaturated siloxane units, preferably from 3 to 15 units, more preferably from 3 to 10 units,
(iii) using at least one functionalization agent for introducing at least one functional group to the polymer, wherein the functional group, preferably, has in addition to C and H atoms at least one heteroatom selected from Si, S, N, O or combinations thereof and wherein (iii) is carried out before, after or during step (ii).

In another aspect there is provided a polydiene rubber obtained by the method above.

In a further aspect there is provided a curable composition comprising the polydiene rubber and further comprising at least one vulcanisation agent for curing the polydiene rubber.

In yet another aspect there is provided a composition comprising a cured polydiene rubber obtained by curing the curable composition.

### DETAILED DESCRIPTION

The present disclosure will be further illustrated in the following detailed description.

In the following description certain standards (ASTM, DIN, ISO etc.) may be referred to. If not indicated otherwise, the standards are used in the version that was in force on Mar. 1, 2020. If no version was in force at that date because, for example, the standard has expired, then the version is referred to that was in force at a date that is closest to Mar. 1, 2020.

All documents recited in this description are incorporated by reference, unless indicated otherwise.

In the following description the amounts of ingredients of a composition or a polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means “parts per hundred parts of rubber”, i.e., the weight percentage of an ingredient of a composition containing one or more rubber is based on the total amount of rubber which is set to 100% by weight. Therefore, total weight of the composition is usually greater than the amount of rubber and can be greater than 100% by weight.

Ranges identified in this disclosure are meant to include and disclose all values between the endpoints of the range and its end points, unless stated otherwise.

The term “comprising” is used in an open, non-limiting meaning. The phrase “a composition comprising ingredients A and B” is meant to include ingredients A and B but the composition may also have other ingredients. Contrary to the use of “comprising” the word “consisting of” is used in a narrow, limiting meaning. The phrase “a composition consisting of ingredients A and B” is meant to describe a composition of ingredients A and B and no other ingredients.

### Siloxane-Based Coupling Agents

The coupling agents according to the present disclosure contain at least 2 unsaturated siloxane units, preferably at least 2 to 20, more preferably from 3 to 15 and most preferably from 4 to 10 unsaturated siloxane units. Therefore, coupling agents according to the present disclosure contain, in addition to —Si—O— units, at least two, preferably at least three, more preferably at least four units having at least one carbon-carbon double bond, preferably vinyl groups (—CH═CH₂ groups). Typically, these units are connected to the silicon atom of the Si—O— unit. Therefore, these units are referred to herein as “unsaturated siloxane units” or “unsaturated —Si—O units”. The coupling agents may be linear or branched, acyclic, cyclic for example monocyclic or polycyclic. Preferably they are cyclic, and preferably they have at least one cyclic structure, preferably a cyclic siloxane structure, i.e., a cyclic structure having at least one unsaturated —Si—O— unit as described above. Preferably, the siloxane-based coupling agents are cyclic and have a cyclic structure with at least two unsaturated siloxane units, more preferably at least three unsaturated siloxane units.

The coupling agents according to the present disclosure preferably are used to couple polydiene rubbers, i.e., to link polymer chains with each other, preferably to create branched, for example multi-armed or star-shaped polymer architectures. The polymer coupling can be observed by an increase of molecular weight measured for example by GPC. The degree of coupling can be determined by comparing the chromatogram of the coupled polymer to the chromatogram of its precursor polymer. Upon coupling a high molecular weight fraction appears in the chromatogram. The ratio of the integral of the coupled fraction to the integral of the whole molecular weight distribution is the degree of coupling (weight % of polymer which is coupled).

An advantage of using the coupling agents according to the present disclosure in the production of polydiene rubbers is that they allow to fine-tune the polymer structure. When the siloxane-based reagents are used in molar excess of their unsaturated units, with respect to polymer chains, the coupled polymer may contain unreacted unsaturated units from the coupling agent that may participate in a cross-linking (vulcanization) reaction. However, if the presence of unsaturated groups from the coupling agent in the polymer is not desired, their presence can be avoided or reduced by using the coupling agents in equimolar or submolar amounts (based on the molar ratio of unsaturated units of the coupling agent to polymer chains). In this case all unsaturated units of the coupling reagent can be expected to have been consumed by the coupling reaction. The molar amount of reactive polymer chains produced in the polymerization reaction can be assumed to be equivalent to the molar amount of polymerization initiator used in the polymerization reaction.

The coupling agent according to the present disclosure comprises from 2 to 20 unsaturated siloxane units, preferably from 3 to 15 unsaturated siloxane units, more preferably from 4 to 10 unsaturated siloxane units, corresponding to the general formula (1):

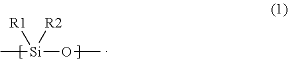

In formula (1) each R1 independently represents an alkenyl group, preferably selected from the group consisting of vinyl (—CH═CH₂), allyl (—CH—CH₂—CH═CH₂), n-propenyl (—CH₂CH═CH₂), n-butenyl (—CH₂CH₂CH═CH₂), isobutenyl (—CH₂(CH₃)CH═CH₂); n-pentenyl (—CH₂CH₂CH₂CH═CH₂), isopentenyl (—CH₂(CH₃)CH₂CH═CH₂, —CH₂CH₂(CH₃)CH═CH₂) and each R2 independently represents H, OH, or an organic residue, preferably having from 1 to 20 carbon atoms, and, optionally having one more heteroatoms selected from O, S, Si, N and a combination thereof. The hydrocarbon residue may be unsubstituted or substituted, where at least one hydrogen atom has been replaced by a substituent. Suitable substituents include siloxanes, polysiloxanes, silyls, aminosilyls, aminosiloxanes, alkylamino-groups, halogens and combinations thereof. Preferably, the hydrocarbon residue is aliphatic. Preferably, the hydrocarbon residue is selected from an alkenyl, preferably having from 2 to 10 carbon atoms, an alkyl preferably having from 1 to 10 carbon atoms, wherein the alkyl or alkenyl chain or both may be interrupted once or more than once by an ether oxygen atom, or R2 is selected from a siloxane or polysiloxane with up to 10 silicon atoms wherein the siloxane or polysiloxane may, optionally, have at least one silicone atom having at least one aliphatic substituent selected from alkyl, alkylene or alkenyl groups or a combination thereof. Preferably, at least one R2 represents methyl, or ethyl. Preferably all R2 represent methyl or ethyl or a combination thereof.

In a preferred embodiment of the present disclosure the siloxane-based coupling agent contains at least one, preferably at least two, more preferably at least three units corresponding to the general formula (2):

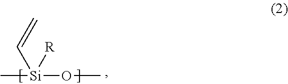

wherein R corresponds to R2 of formula (1) above. Preferably, R is selected from an alkyl having 1 to 10 carbon atoms and that may, optionally contain one more oxygen-ether atoms, and may be an alkoxy or polyalkoxy residue, or may, optionally contain one or more silane-groups, siloxane groups or polysiloxane groups wherein the polysiloxane or siloxane groups may contain from 1 to 3 alkyl or alkenyl residue on the silicon atoms and the maximum number of silicon atoms, preferably, is less than 10. Preferably, R is a C₁-C₁₀-alkyl group, more preferably a C₁-C₇-alkyl group and most preferably R is methyl.

In another preferred embodiment of the present disclosure the unsaturated siloxane coupling agent is cyclic and corresponds to the formula (3)

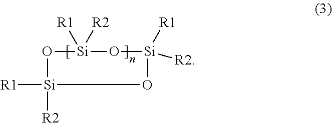

wherein n is 1, 2, 3 or 4, preferably n is 1 or 2, and each R1 is as described in formula (1) and preferably at least one, more preferably all R1 represent a vinyl (—CH═CH₂) group. Each R2 is as described in formula (1) above. Preferably at least one R2 is a C₁-C₇-alkyl group and more preferably at least one R2 is methyl. Most preferably all R2 represent a methyl group.

In one embodiment of the present disclosure the unsaturated siloxane coupling agent corresponds to the general formula (4):

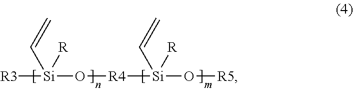

wherein n is an integer of 1 to 20 and m is integer of 1 to 20, and each residue R is selected independently from each other and is as described for formula (2) above, and
R3 is H, OH, a saturated or unsaturated hydrocarbon with 1 to 10 carbon atoms, a monovalent siloxane, polysiloxane or silane, or R3 connects to R5 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R3 and R5 jointly form a chemical bond to form a cyclic compound, and
R4 is a linker group selected from (i) aliphatic hydrocarbons having from 1 to 20 carbon atoms that may optionally contain one or more oxygen ether groups, (ii) one or more silane or siloxane groups or combinations thereof, wherein one or more than one silicon atom may carry one or more aliphatic hydrocarbon groups having from 1 to 10 carbon atoms or a combination of (i) and (ii), and
R5 is H, OH, a saturated or unsaturated hydrocarbon with 1 to 10 carbon atoms, a monovalent siloxane, polysiloxane or silane, or R5 is connected to R3 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R5 connects to R3 to form a cyclic compound and represents a bivalent siloxane or polysiloxane with 1 to 10 silicon atoms and wherein one or at least one of the silicon atoms carries one or more alkyl or alkenyl residues having from 1 to 10 carbon atoms, or R3 and R5 jointly form a chemical bond to form a cyclic compound.

In another preferred embodiment of the present disclosure a polycyclic coupling agent is used. Suitable examples of polycyclic agents include those corresponding to formula (5):

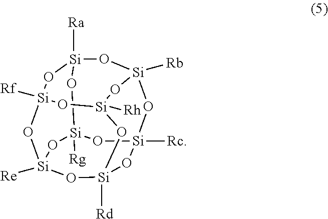

In formula (5) Ra, Rb, Rc, Rd, Re, Rf, Rg and Rh are identical or different from each other and are selected independently from each other a C₁-C₁₀-alkyl, a C₂-C₆-alkenyl, a —O—Si—(R_{1′}R_{2′}R_{3′}), wherein R1′, R2′ and R3′ are selected independently from each other from a C₁-C₁₀-alkyl, a C₂-C₆-alkenyl, preferably vinyl, preferably at least one of R1′, R2′ and R3′ comprises a vinyl unit, preferably all of R1′, R2‘ and R’3 are vinyl (—CH═CH₂). At least one, preferably at least two, more preferably at least three of Ra, Rb, Rc, Rd, Re, Rf, Rg and Rh comprises a C₂-C₆-alkenyl, preferably a vinyl (—CH═CH₂). In one embodiment of a polycyclic coupling agent according to formula (5) at least four of Ra—Rh are vinyl or at least one of residues Ra—Rh is —O—Si(vinyl)₃. In another embodiment of a compound according to formula (5) all of Ra—Rh are vinyl. Compounds according to formula (5) are also known as polyhedral oligomeric silsesquioxanes or POSS. The materials are commercially available or can be prepared as described, for example, in Quirk, Cheng et al in Macromolecules 2012, 45, 21, 8571-8579.

Preferably, the coupling agent according to the present disclosure has a molecular weight of up to and including 5000 g/mol. Preferably the coupling agent has a molecular weight of less than 2000 g/mol.

Particularly preferred examples of coupling agents according to the present disclosure include

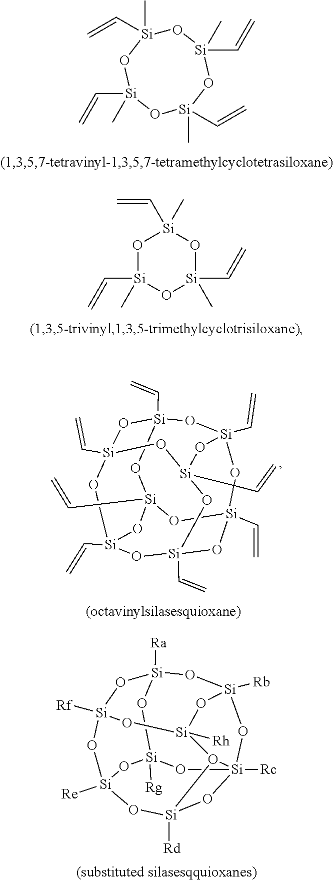

wherein residues Rb to Rg independently represent a C₁-C₇-alkyl, preferably a cyclopentyl, and Ra is —O—Si(—CH═CH₂)₃. Combinations of one or coupling agents according to the present disclosure may be used as well as combinations of one or more coupling agents of the present disclosure with one or more other coupling agents.

### Polymers

In one aspect of the present disclosure polymers are provided that can be obtained by a method comprising (i) polymerizing at least one conjugated diene monomer to produce polymers having reactive chain ends and (ii) reacting at least some of the reactive polymer chain ends with at least one of the siloxane-based coupling agents according to the present disclosure. The conjugated diene monomers preferably have from 4 to 25, more preferably from 4 to 20 carbon atoms.

The polymers may be homopolymers or copolymers and comprise units derived from at least one conjugated diene monomer. Suitable diene monomers include but are not limited to 1,3-butadiene, isoprene, 1,3-pentadiene, 2,3-dimethylbutadiene, 1-phenyl-1,3-butadiene, 1,3-hexadiene, myrcene, ocimene, farnesene and combinations thereof. Preferably the polymer comprises units derived from 1,3-butadiene or consists of units derived from 1,3-batdiene.

In one embodiment of the present disclosure the polymer is a copolymer obtained by a method comprising a polymerization reaction comprising at least two conjugated dienes. In another embodiment the present disclosure the polymer is a copolymer obtained by a method comprising polymerizing at least one conjugated diene monomer and at least one vinylaromatic comonomer. Examples of suitable vinyl aromatic comonomers include, but are not limited to, styrene, ortho-methyl styrene, meta-methyl styrene, para-methyl styrene, para-tertbutyl styrene, vinyl naphthalene, divinyl benzene, trivinyl benzene, divinyl naphthalene and combinations 2,4-dimethylstyrene, 2,4,6-trimethylstyrene, a-methylstyrene, 2,4-diisopropyl-styrene and 4-tert-butylstyrene, stilbene, vinyl benzyl dimethylamine, (4-vinylbenzyl)dimethyl aminoethyl ether, N,N-dimethylaminoethyl styrene, tert-butoxystyrene, vinylpyridine or amino substituted derivatives (N,N-Dimethylaminomethylstyrol) or copolymerizable vinylsilanes or multivinylsilanes with amino groups (e.g. 1,4-Bis[dimethyl(vinyl)silyl]piperazine), vinylaminodisiloxane or butadienylaminodisiloxane monomers such as 4-[3-(tert-butyl)-1,3,3-trimethyl-1-vinyldisiloxanyl]morpholine, 3-(tert-butyl)-N,N-diethyl-1,3,3-trimethyl-1-vinyl-disiloxan-1-amine and 3-(tert-butyl)-N,N-dibutyl-1,3,3-trimethyl-1-vinyldisiloxan-1-amine thereof. Styrene is particularly preferred.

In one embodiment of the present disclosure the polymers are butadiene polymers and include homopolymers and copolymers of 1,3-butadiene. Preferably, the polymers according to the present disclosure contain at least 51% by weight, preferably at least 60% by weight, based on the weight of the polymer, of units derived from 1,3-butadiene. In one embodiment of the present disclosure the diene polymers contain at least 60% by weight, or at least 75% by weight units derived from 1,3-butadiene.

In one embodiment of the present disclosure the diene polymers contain from 0 to 49% by weight, or from 0% to 40% by weight, based on the total weight of the polymer, of units derived from one or more comonomers.

In one embodiment of the present disclosure the diene polymers contain at least 60% by weight, or at least 70% by weight units derived from 1,3-butadiene and from 0 to 40% by weight, or from 0 to 30% by weight of units derived from one or more comonomers.

In one embodiment the diene polymers of the present disclosure contain from 0 to 20% by weight of units derived from one or more conjugated dienes other than 1,3 butadiene.

In one embodiment the diene polymers according to the present disclosure contain up to 49% by weight of units derived from one or more vinylaromatic comonomer, preferably from 5% to 40% by weight of units derived from one or more vinylaromatic comonomer.

Preferably, the diene polymers of the present disclosure contain up to 49% by weight, based on the weight of the polymer, or from 0 to 40% by weight, of units derived from styrene.

In one embodiment the polymer according to the present disclosure comprises at least 75% or at least 95% by weight of units derived from one or more than conjugated diene monomers. In one embodiment the polymer according to the present disclosure comprises from 55% to 92% by weight of units derived from one or more conjugated diene monomers and from 5.8% to 45% by weight of units derived from vinyl aromatic comonomers.

Suitable copolymerizable comonomers further include one or more alpha-olefins, for example, ethene, propene, 1-butene, 1-pentene, 1-hexene, 4-methyl-1-pentene, 1-octene and combinations thereof.

In one embodiment, the diene polymers according to the present disclosure contain from 0 to 20% by weight of units derived from ethene, propene, 1-butene, 1-pentene, 1-hexene, 4-methyl-1-pentene, 1-octene and combinations thereof.

Suitable comonomers also include, but are not limited to, one or more other copolymerizable comonomers that introduce functional groups including cross-linking sites, branching sites, branches or functionalized groups. In one embodiment of the present disclosure the diene polymers contain from 0% to 10% by weight or from 0% to 5% by weight of units derived from one or more of such other comonomers.

Combinations of one or more of the comonomers of the same chemical type as described above as well as combinations of one or more comonomers from different chemical types may be used.

The diene polymers according to the present disclosure may have a Mooney viscosity ML 1+4 at 100° C. of from 10 to 200 Mooney units, for example from 30 to 150 or from 35 to 85 Mooney units.

The diene polymers according to the present disclosure may have a number-averaged molecular weight (Mn) of from 10,000 g/mol to 2,000,000 g/mol, or from 100,000 to 1,000,000 g/mol, for example from 100,000 to 400,000 g/mol or from 200,000 to 300,000 g/mol. In one embodiment of the present disclosure, the polymers have an Mn of from 150 kg/mol to 320 kg/mol.

The diene polymers according to the present disclosure may have a dispersity (also referred to herein as molecular weight distribution or MWD) from 1.03 to 25, for example from 1.03 to 5. In one embodiment of the present disclosure the polymers have an MWD of from 1.03 to 3.5 or from 1.03 to 2.0. The MWD is the ratio of the weight-averaged molecular weight (Mw) to the number averaged molecular weight Mn, i.e., MWD equals Mw/Mn.

The diene polymers according to the present disclosure are rubbers and typically have a glass transition temperature of less than 20° C. They may have a glass transition temperature (Tg), for example, of from −120° C. to less than 20° C. In a preferred embodiment of the present disclosure the polymers have a Tg of from 0° C. to −110° C. or from −10° C. to −80° C. In one embodiment of the present disclosure the butadiene polymer has a glass transition temperature of from about −50 to −80° C.

In one embodiment of the present disclosure the diene polymers have a number-averaged molecular weight of from 100,000 to 1,000,000 and a Mooney viscosity ML 1+4 at 100° C. of from 30 to 150 units and a glass transition temperature of from −110° C. to 0° C. In one embodiment the diene polymers according to the present disclosure have a Mooney viscosity ML 1+4 at 100° C. of from 30 to 150 units, a number-averaged molecular weight of from 100,000 to 400,000 g/mole, a glass transition temperature of from −110° C. to 0° C. and a molecular weight distribution (MWD) from 1.03 to 20.

The diene polymers according to the present disclosure may be additionally functionalized- and may contain one or more functional groups, preferably an end group, containing, in addition to C and H atoms, at least one heteroatom selected from Si, S, N, O and a combination thereof. Preferably, the functional group has from 1 to 20 carbon atoms. Therefore, for making the polymers according to the present disclosure at least one functionalization agent for introducing a functional group is used. The functionalization agent may be selected from a functionalized copolymerizable comonomer, an alpha-functionalizing agent, for example a functionalised initiator, or a non-copolymerizable functionalizing agent capable of introducing functional groups at the terminal end (omega-position) of the polymer or a combination thereof.

Such additionally functionalized polymers are obtainable, for example, by a reaction comprising reacting the reactive polymer chain ends with at least one functionalization reagent containing, in addition to C and H atoms, at least one heteroatom selected from Si, S, N, O and combinations thereof. The at least one functionalization reagent may be reacted with the polymer before, while or after, preferably after, reacting the polymer with the coupling agent. If necessary, the reaction product of the functionalization reaction may subsequently be treated to generate at least one —OH, —SH, —COOH —NR₂H⁺, —NR₃⁺, —NH₃⁺ group or a combination thereof or an anionic form thereof selected from —O—, —S—, —COO⁻ groups, or a non-ionic form in case of the amino groups, or combinations thereof. Such treatment may include carrying out a hydrolysis reaction, for example by adding an alcohol or an acid, by steam stripping, or a treatment with at least one other functionalization reagent that reacts with the first functionalization reagent to produce at least one —OH, —SH, or —COOH group or a combination thereof or an anionic form thereof selected from —O⁻, —S⁻, —COO⁻, or an amino group as shown above.

### Methods of Making Polymers

The homo- or copolymers of the present disclosure can be prepared by methods known in the art. The polymerization may be carried out to produce a statistical polymer, also called random copolymer, a block-copolymer, a gradient copolymer or combinations of them and include linear and branched architectures as known by the person skilled in the art.

The polymers can be obtained by a process comprising an anionic polymerization or a catalytic polymerization using one or more coordination catalysts. Coordination catalysts in this context include Ziegler-Natta catalysts or monometallic catalyst systems. Preferred coordination catalysts are those based on Ni, Co, Ti, Zr, Nd, V, Gd, Cr, Mo, W or Fe. Preferably the polymerization reaction comprises an anionic solution polymerization. Initiators for anionic solution polymerization include organometals, preferably based on alkali or alkaline earth metals. Examples include but are not limited to methyllithium, ethyllithium, isopropyllithium, n-butyllithium, sec-butyllithium, pentyllithium, n-hexyllithium, cyclohexyllithium, octyllithium, decyl-lithium, 2-(6-lithio-n-hexoxy)tetrahydropyran, 3-(tert-butyldimethylsiloxy)-1-propyllithium, [3-(dibutylamino)propyl]lithium, [(dibutylamino)-dimethylsilyl]-methyllithium, phenyllithium, 4-butylphenyllithium, 1-naphthyllithium, p-toluyllithium and allyllithium compounds, derived from tertiary N-allylamines such as [1-(dimethylamino)-2-propenyl]lithium, [1-[bis(phenylmethyl)amino]-2-propenyl]lithium, [1-(diphenylamino)-2-propenyl]lithium, [1-(1-pyrrolidinyl)-2-propenyl]lithium, lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. The allyllithium compounds and the lithium amides can also be prepared in situ by reacting an organolithium compound with the respective tertiary N-allylamines or with the respective secondary amines. Di- and polyfunctional organolithium compounds can also be used, for example 1,4-dilithiobutane, dilithium piperazide. Preferably n-butyllithium, sec-butyllithium or a combination thereof are used. The initiator creates anionic, reactive monomers and the polymerization propagates by the reaction of the reactive carbanionic monomers with other monomers which creates reactive carbanionic polymer chain ends. In case of a polymerization using one or more coordination catalysts, the reactive chain ends are produced by the catalyst.

Randomizers and control agents as known in the art can be used in the polymerization for controlling the structure of the polymer, in particular for avoiding aggregations or for randomizing the monomer distribution. Such agents include, for example, diethyl ether, di-n-propylether, diisopropyl ether, di-n-butylether, ethylene glycol dimethyl ether, ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methyl-propane, triethylene glycol dimethyl ether, tetrahydrofuran, ethyltetrahydrofurfuryl ether, hexyltetrahydrofurfuryl ether, 2,2-bis(2-tetrahydrofuryl)propane, dioxane, trimethylamine, triethylamine, N,N,N′,N′-tetramethyl-ethylenediamine, N-methylmorpholine, N-ethylmorpholine, 1,2-dipiperidinoethane, 1,2-dipyrrolidinoethane, 1,2-dimorpholinoethane, potassium and sodium salts of alcohols, phenols, carboxylic acids, sulphonic acids and combinations thereof. In one embodiment of the present disclosure the polymer is a random polymer and, preferably, at least one randomizer is used in the polymerization reaction.

In one embodiment of the present disclosure the polymer is a random polymer. In one embodiment the polymer is a block-copolymer. For the generation of block copolymers, the polymerization is preferably started with one monomer and subsequently, depending on the size of the blocks to be performed the other (co)monomer(s) are added. The sequence of monomer additions can be adapted depending on which blocks of different monomers are desired to be created. In one embodiment of the present disclosure such a block is created at the beginning or at the end of the polymerization or both.

In one embodiment the polymerization is carried out in the presence of at least one solvent and preferably in solution. Preferred solvents for solution polymerizations include inert aprotic solvents, for example aliphatic hydrocarbons. Specific examples include, but are not limited to, butanes, pentanes, hexanes, heptanes, octanes, decanes and cyclopentane, methylcyclopentane, cyclohexane, methylcyclohexane, ethylcyclohexane, 1,4-dimethylcyclohexane and combinations thereof and including isomers thereof. Further examples include alkenes such as 1-butene or aromatic hydrocarbons such as benzene, toluene, ethylbenzene, xylene, diethylbenzene or propylbenzene and combinations thereof. These solvents can be used individually or as mixtures. Preferred solvents include cyclohexane, methylcyclopentane and n-hexane. The solvents may also be mixed with polar solvents if appropriate.

The polymerization can be carried out by first introducing the (co)monomers and solvent and then starting the polymerization by adding initiator or catalyst. The polymerization may also be carried out in a feed process where the polymerization reactor is filled by adding monomers and solvents. The initiator or catalyst are introduced or added with the monomers and solvent. Variations may be used, such as introducing the solvent in the reactor, adding initiator or catalyst followed by adding the monomers. The polymerization can be carried out in a continuous mode or batchwise. Further monomer and solvent may be added during or at the end of the polymerization.

The polymerization can be carried out at normal pressure or at elevated pressure (for example, from 1 to 10 bar) or at reduced pressure. Typical reaction temperatures include room temperature but depending on the nature and amounts of comonomers the reaction temperature may be above or below room temperature. Typical ranges include, for example from −12° C. to 140° C. in a continuous adiabatic process, or from 50 to 120° C. in a batch process.

The polymerization reaction leads to reactive polymer chain ends, preferably anionic chain ends. The polymerization mixture or solution containing reactive polymer chain ends is contacted with at least one of the siloxane-based coupling agents according to the present disclosure at the desired progression of the polymerization reaction, for example when the desired conversion rate or the desired molecular weight range of the polymer has been reached. Typically, it is desired to carry out the coupling reaction at the end of the polymerization reaction, for example after at least 90%, or at least 95% of the monomers have been consumed. For example, the coupling agent may be added before or after the monomer feed has been stopped or discontinued. The coupling agent may be added as pure substance or as solution or dispersion. Although not preferred and not necessary, coupling agents other than the unsaturated siloxanes according to the present disclosure may be used in addition. Typically, the addition of the coupling agent is carried out at a reaction temperature of 20° C. to 130° C., or from 50° C. to 130° C.

Another advantage of using the siloxane-based coupling agents for producing diene rubber is that the polymers obtained by using them can be functionalized further to produce diene rubbers with additional functional groups, preferably end groups, preferably end groups suitable for use in tire applications, for example in tire tread compositions. In one embodiment of the present disclosure the polymer is omega-functionalized, alpha-functionalized, or alpha- and omega-functionalized. The polymer also may be in-chain-functionalized, for example by using functionalized comonomers introducing functional groups into the polymer back bone or as pending side groups.

### Omega-Functionalization:

In one embodiment of the present disclosure, the method according to the present disclosure may further comprise a step of reacting the polymer with at least one functionalization agent for introducing at least one functional group to the polymer, wherein this step may be carried out before, after or during step (ii).

Typically, functionalization agents capable for introducing functional groups at the terminal end of the polymer, i.e. at the omega position, are aliphatic compounds containing in addition to carbon and hydrogen atoms, heteroatoms selected from Si, O, S and N, preferably combinations of heteroatoms selected from Si and O, combinations of selected from Si, O and S, and combination of Si, O and N, or combinations of N and O. Typically, they lead, either directly or upon hydrolysis or reaction with another functional agent or both, to the polymer having at least one polar group selected from —OH, —COOH, —SH, —NR₂H⁺, —NR₃⁺, —NH₃⁺ or the respective ionic or non-ionic form and salts thereof and combinations thereof. Preferably, R represents, independently, an organic residue having from 1 to 12 carbon atoms, preferably alkyl groups. Typically, the functionalization agent has a molecular weight of less than 5,000 g/mole or even less than 2,000 g/mole. Typically, the functionalization agents are not comonomers. Functionalization reagents as known in the art may be used. Examples of functionalization agents include but are not limited to linear or branched alkoxysilanes and those described in US2013/0281605A1, US2013/0338300A1, US2013/0280458A1, US2016/0075809A1, US2016/0083495A1, WO2021/009154A1, U.S. Pat. No. 4,894,409, US2018/0037674A1 and WO2021/009156.

Preferred functionalization reagents include reagents having at least one functional group selected from carboxylic acid anhydride groups, cyclic carbamide ((O═)C(NR′—)(NR′—)) groups, tertiary alkylamino groups ((R′)₂N—), linear or branched, cyclic or acyclic siloxanes, cyclic, acyclic, linear or branched silanes and combinations thereof. Preferred silanes or siloxanes include molecules having at least one (R)₃Si—N— group, (R₃)Si— group; (R)₃Si—S— group; (R)₂Si(—O—)— group or a combination thereof. In the above formulae each R represents, independently, an alkyl, alkoxy, having from 1 to 12 carbon atoms, preferably 1 to 6 carbon atoms, R′ represents an alkyl or alkylsilyl having from 1 to 12 carbon atoms, preferably 1 to 6 carbon atoms. Preferably, the reagent is aliphatic. “X−” indicates the atom “X” is bonded to an organic residue for example to a carbon atom of an organic residue, for example a carbon atom of an alkyl, alkylene, heteroalkyl or heteroalkylene, for example an azaalkylene or a thiaalkylene, which may be cyclic or non-cyclic. Heteroralkyl or heteroalkylene means an alkyl or alkylene group having at least one heteroatom-containing functional group. The heteroatom preferably is selected from Si, S, O and N.

Preferred functionalization agents include anhydrides, linear or branched, cyclic or acyclic, alkoxysilanes (siloxanes), linear or branched silanes, linear or branched, preferably cyclic carbamides. Specific examples include, but are not limited to, the reagents selected from the group consisting of:

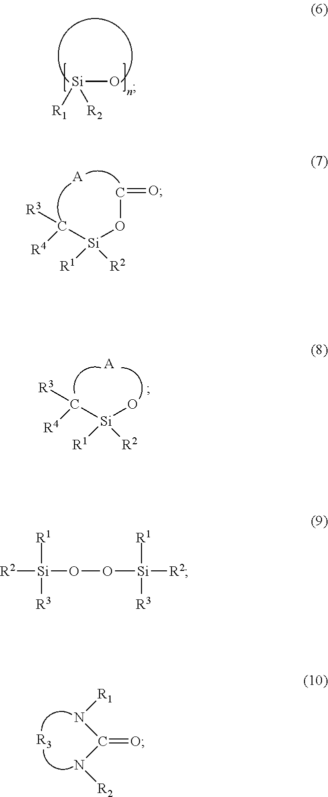

((RO)ₓ(R)_{y}Si—R″—S—(R′) (12); (RO)ₓ(R)_{y}Si—R″—N(—R′)₂ (13) and combinations thereof.

In one embodiment of the present disclosure the functionalization reagent is a linear or branched silane or siloxane. In another embodiment of the present disclosure the functionalization reagent is a cyclic reagent. In one embodiment of the present disclosure the functionalization reagent is cyclic and has a 4- to 7-membered aliphatic cyclic ring, more preferably 5- or 6-membered aliphatic cyclic ring wherein the ring either has at least 2, preferably at least 3 carbon atoms and at least one heteroatom selected from N, O, S, Si or is a combination thereof. In another embodiment of the present disclosure the functionalization reagent is cyclic and has a 3- to 20-membered cyclic structure wherein the ring has at least two, preferably at least three —Si(R1R2)-O— units, wherein R1 and R2 are, independently from each other, selected from H, a C₁-C₁₀ saturated hydrocarbon residue that, optionally, may contain one or more heteroatoms selected from O, N, S, Si or a combination thereof. Preferably, R1 and R2 are selected from methyl, ethyl, propyl and butyl. In one embodiment of the present disclosure the polymer does not have an amino end group. In another embodiment of the present disclosure the polymer does not have a thiol endgroup.

Functionalization Reagents according to formula (6):

Reagents according to formula (6) include cyclosiloxane-based functionalization reagents. In formula (6) R₁ and R₂ are the same or different and correspond to H, C₁-C₁₀ saturated hydrocarbon residue, preferably methyl, ethyl, propyl and butyl, and wherein the C₁-C₁₀ saturated hydrocarbon residue, optionally, contains one or more heteroatoms selected from O, N, S, Si or a combination thereof, and n is an integer selected from 3 to 10, preferably 4 to 6. Specific examples of reagents according to formula (6) include but are not limited to hexamethylcyclotrisiloxane, octamethylcyclotetrasiloxane, decamethylcyclopentasiloxane and dodecamethylcyclohexasiloxane, Reagents according to formula (6) can lead directly or indirectly (for example via a subsequent hydrolysis) to silanol (—Si(R₁)(R₂)—OH) or silanolate (—Si(R₁)(R₂)—O) groups) as described, for example in US2016/0075809A1.

Functionalization reagents according to formula (7):

Reagents according to formula (7) include silalactone-based functionalization reagents. In formula (7) R¹ and R² are the same or different and are each selected from H or a residue having from 1 to 20 carbon atoms, preferably selected from alkyls, alkoxys, cycloalkyls, cycloalkoxys, aryls, aryloxys, alkaryls, alkaryloxy, aralkyls, or aralkoxys;
R³, R⁴ are the same or different and are each selected from H or a residue having from 1 to carbon atoms, preferably from alkyl, cycloalkyl, aryl, alkaryl or aralkyl,
A is a divalent organic radical, preferably having from 1 to 26 carbon atoms, and which may, in addition to hydrogen atoms, comprise heteroatoms selected from O, N, S and Si.

Preferably R¹, R² are the same or different and are selected from H, a (C₁-C₂₄)-alkyl, a (C₁-C₂₄)-alkoxy, a (C₃-C₂₄)-cycloalkyl, a (C₃-C₂₄)-cycloalkoxy, a (C₆-C₂₄)-aryl, a (C₆-C₂₄)-aryloxy, a (C₆-C₂₄)-alkaryl, a (C₆-C₂₄)-alkaryloxy, a (C₆-C₂₄)-aralkyl or a (C₆-C₂₄)-aralkoxy radical which, optionally, may contain one or more heteroatoms selected from O, N, S or Si.

Preferably R³, R⁴ are the same or different and are each selected from H, a (C₁-C₂₄)-alkyl, a (C₃-C₂₄)-cycloalkyl, a (C₆-C₂₄)-aryl, a (C₆-C₂₄)-alkaryl or a (C₆-C₂₄)-aralkyl radical, optionally containing one or more heteroatoms, selected from O, N, S or Si.

In one embodiment of the present disclosure A is represented by:
Xn-(CY1H)m-(CY2Y3)o-(CY1H)p- where n is 1 or 0, m is 1, 2, 3 or 4, o is 0, 1 or 2, p is 0, 1 or 2, preferably the sum of n, m, o and p is 2 or 3;
X is O, S, NR, where R is H or C₁-C₃ alkyl or X is N(Si(alkyl)₃), wherein each “alkyl” independently from each other represents a C₁ to C₆ alkyl, -oxyalkyl or alkoxy;
Y1 is H or C₁-C₃ alkyl, Y2 is H or C₁-C₃ alkyl, Y3 is H or C₁-C₃ alkyl, preferably at least one of Y2 and Y3 is H.

Specific, non-limiting—examples of A include:
—CH₂—; —CH₂CH₂—; —CH₂CH₂CH₂—; —C(CH₃)—CH₂—; —CH₂—C(CH₃)—CH—; —CH(CH₃)—C(CH₃)H—; —CH(CH₃)—CH₂—C(CH₃)H—; —CH₂—C(CH₃)H—C(CH₃)H—; —CH(CH₃)—C(CH₃)H—CH₂—; —O—CH₂—; —O—CH₂CH₂—; —O—CH₂CH₂—CH₂—; —O—C(CH₃)H—; —O—CH₂CH₂—; —O—C(CH₃)H—CH₂—; —O—CH₂—C(CH₃)H—; —O—CH₂—C(CH₃)H—CH₂—; —O—CH₂CH₂—C(CH₃)H—; —O—C(CH₃)H—CH₂—CH₂—; —S—CH₂—; —S—CH₂CH₂—; —S—CH₂CH₂—CH₂—; —S—C(CH₃)H—; —S—CH₂CH₂—; —S—C(CH₃)H—CH₂—; —S—CH₂—C(CH₃)H—; —S—CH₂—C(CH₃)H—CH₂—; —S—CH₂CH₂—C(CH₃)H—; —S—C(CH₃)H—CH₂—CH₂—;
—NH—CH₂—; —NH—CH₂CH₂—; —NH—CH₂CH₂—CH₂—; —NH—C(CH₃)H—CH₂—; —NH—CH₂—C(CH₃)H—; —NH—CH₂—C(CH₃)H—CH₂—; —NH—CH₂CH₂—C(CH₃)H—; —NH—C(CH₃)H—CH₂—CH₂—; —N(CH₃)—CH₂—; —N(CH₃)—CH₂—; —N(CH₃)—CH₂CH₂—; —N(CH₃)—CH₂CH₂—CH₂—; —N(CH₃)—C(CH₃)H—CH₂—; —N(CH₃)—CH₂—C(CH₃)H—; —N(CH₃)—CH₂—C(CH₃)H—CH₂—; —N(CH₃)—CH₂CH₂—C(CH₃)H—; —N(CH₃)—C(CH₃)H—CH₂—CH₂—; N(Si(alkyl)₃)—CH₂—; —N(Si(alkyl)₃)—CH₂CH₂—; N(Si(alkyl)₃)—CH₂CH₂CH₂—; —N(Si(alkyl)₃)—C(CH₃)H—; —N(Si(alkyl)₃)—CH₂CH₂—; —N(Si(alkyl)₃)—C(CH₃)H—CH₂—; —N(Si(alkyl)₃)—CH₂—C(CH₃)H—; —N(Si(alkyl)₃)—CH₂—C(CH₃)H—CH₂—; —N(Si(alkyl)₃)—CH₂CH₂—C(CH₃)H—; —N(Si(alkyl)₃)—C(CH₃)H—CH₂—CH₂—.

Examples of reagents according to formula (7) include:

2,2-dimethyl-1-oxa-2-silacyclohexan-6-one, 2,2,4-trimethyl-1-oxa-2-silacyclohexan-6-one, 2,2,5-trimethyl-1-oxa-2-silacyclohexan-6-one, 2,2,4,5-tetramethyl-1-oxa-2-silacyclohexan-6-one, 2,2-diethyl-1-oxa-2-silacyclohexan-8-one, 2,2-diethoxy-1-oxa-2-silacyclohexan-6-one, 2,2-dimethyl-1,4-dioxa-2-silacyclohexan-6-one, 2,2,5-trimethyl-1,4-dioxa-2-silacyclohexan-6-one, 2,2,3,3-tetramethyl-1,4-dioxa-2-silacyclohexan-6-one, 2,2-dimethyl-1-oxa-4-thia-2-silacyclohexan-6-one, 2,2-diethyl-1-oxa-4-thia-2-silacyclohexan-6-one, 2,2-diphenyl-1-oxa-4-thia-2-silacyclonexan-6-one, 2-methyl-2-ethenyl-1-oxa-4-thia-2-silacyclohexan-6-one, 2,2,5-trimethyl-1-oxa-4-thia-2-silacyclohexan-6-one, 2,2-dimethyl-1-oxa-4-aza-2-silacyclohexan-6-one, 2,2,4-trimethyl-1-oxa-4-aza-2-silacyclohexan-6-one, 2,4-dimethyl-2-phenyl-1-oxa-4-aza-2-silacyclohexan-6-one, 2,2-dimethyl-4-trimethylsilyl-1-oxa-4-aza-2-silacyclohexan-8-one, 2,2-diethoxy-4-methyl-1-oxa-4-aza-2-silacyclohexan-6-one, 2,2,4,4-tetramethyl-1-oxa-2,4-disilacyclohexan-8-one, 3,4-dihydro-3,3-dimethyl-1H-2,3-benzoxasilin-1-one, 2,2-dimethyl-1-oxa-2-silacyclopentan-5-one, 2,2,3-trimethyl-1-oxa-2-silacyclopenten-5-one, 2,2-dimethyl-4-phenyl-1l-oxa-2-silacyclopentan-5-one, 2,24(tert-butyl)-1-oxa-2-silacyclopentan-5-one, 2-methyl-2-(2-propen-1-yl)-1-oxa-2-silacyclopentan-5-one, 1,1-dimethyl-2,1-benzoxasilol-3(1H)-one, 2,2-dimethyl-1-oxa-2-silacycloheptan-7-one.

Reagents according to formula (7) are described, for example, in US2016/0075809A1, in particular in [0034]-[0042]. The use of such a reagent alone or by adding it to another functionalization reagent, for example a reagent according to formula (6) can lead to the creation of silacarboxylate groups, for example groups according to the general formula —Si(R¹)(R²)—C(R³)(R⁴)-A-COO⁻.

Functionalization reagents according to formula (8):

Reagents according to formula (8) include oxa-silacycloalkanes. In formula (8) R¹, R², R³, R⁴ and A are the same as described for formula (7).

Examples of specific reagents according to formula (8) include:

2,2-dimethyl-1-oxa-2-silacyclohexane, 2,2-diethyl-1-oxa-2-silacyclohexane, 2,2-dipropyl-1-oxa-2-silacyclohexane, 2-methyl-2-phenyl-1-oxa-2-silacyclohexane, 2,2-diphenyl-1-oxa-2-silacyclohexane, 2,2,5,5-tetramethyl-1-oxa-2-silacyclohexane, 2,2,3-trimethyl-1-oxa-2-silacyclohexane, 2,2-di methyl-1-oxa-2-silacyclopentane, 2,2,4-trimethyl-1-oxa-2-silacyclopentane, 2,2-dimethyl-1,4-dioxa-2-silacyclohexane, 2,2,55-tetramethyl-1,4-dioxa-2,5-disilacyclohexane, 2,2,4-trimethyl-1-oxa-4-aza-2-silacyclohexane, benzo-2,2-dimethyl-1,4-dioxa-2-silacyclohexane, benzo-2,2,4-trimethyl-1-oxa-4-aza-2-silacyclohexane. Reagents according to formula (8) are described, for example in US2013/0281605A1. The use of reagents according to formula (8) may lead to carbinol groups corresponding to the formula —S(R¹)(R²)—C(R³)(R⁴)-A-OH.

Functionalization reagents according to formula (9):

The reagents according to formula (9) include bis(trialkylsilyl) peroxides. R¹, R², and R³ can be identical or different and are selected from linear or branched or cyclic alkyls which, optionally, can comprise heteroatoms selected from O, N, S, and Si and a combination thereof. Preferably, they are selected from C1-C10 linear alkyls and preferably they are all identical. Preferably at least one of R¹, R² and R³ is methyl and more preferably all are methyl.

Functionalization reagents according to formula (10):

The reagents according to formula (10) include cyclic ureas. In formula (10) R₃ represents a divalent, saturated or unsaturated, linear or branched, preferably aliphatic, hydrocarbon group having from 1 to 20 carbon atoms which, in addition to C and H, may contain one or more heteroatoms, preferably independently of one another selected from O, N, S or Si. Preferably R₃ corresponds to the general formula (11):

—[CHX¹]ₒ[CHX²]ₚ—[O]_{z}—[CHX³]_{q}— (11)

wherein z is 1 or 0, o, p and q are independently selected from 0, 1 and 2 with the proviso that at least one of o, p and q is not 0. X¹, X² and X³ are independently selected from H and linear or branched alkyl, alkylaryl and aryl groups having from 1 to 12 carbon atoms and from aminoalkyl (N—R) groups wherein R is a linear or branched or cyclic alkyl or alkylaryl residue having from 1 to 12 carbon atoms, and X¹ and X² may represent a chemical bond between to form a carbon-carbon bond to provide an unsaturation in the carbon chain. o, p, q, X¹, X² and X³ are selected such that the total number of carbon atoms is not more than 20.

In one embodiment of the present disclosure R₃ is selected from substituted alkylenes, for example from substituted alkylenes corresponding to formula (11) wherein at least one of X¹, X² and X³ is not H.

In one embodiment of the present disclosure R₃ is selected from unsubstituted alkylenes, for example from unsubstituted alkylenes corresponding to formula (11) wherein all of X¹, X² and X³ are H. In a preferred embodiment R₃ corresponds to —[(CH)₂]ₙ—, wherein n is an integer from 1 to 5, preferably 1 to 3, more preferably 1 or 2.

In one embodiment of the present disclosure R₃ is selected from unsaturated substituted or unsubstituted alkylenes and, for example, corresponds to formula (IIa) wherein X¹ and X² together form a carbon-carbon bond. Specific examples of unsaturated alkylenes include but are not limited to —CH═CH— or —CH₂—CH═CH—.

In formula (10) R₁ and R₂ are identical or different and represent saturated or unsaturated hydrocarbon groups having from 1 to 20 carbon atoms and wherein the hydrocarbon group may contain, in addition to C and H atoms, one or more heteroatoms, preferably selected from the group consisting of O, N, S and Si. For example, R₁ and R₂ may be identical or different and are selected from —(C₁-C₂₀)-alkyl, —(C₃-C₂₀)-cycloalkyl, —(C₆-C₂₀)-aryl, —(C₆-C₂₀)-alkaryl or —(C₆-C₂₀)-aralkyl radicals which may contain one or more heteroatoms, preferably independently selected from O, N, S or Si. Preferably R₁, R₂ are selected independently from each other from methyl, ethyl, n-propyl, isopropyl, n-butyl, sec-butyl, tert-butyl, trialkyl silyl with alkyl groups of 1 to 4 carbon atoms per alkyl group, phenyl and phenyls independently substituted with one, two or three methyl-, ethyl-, propyl, and/or- butyl residues.

Preferred specific examples of agents according to formula (10) include but are not limited to: 1,3-dimethyl-2-imidazolidinone, 1,3-diethyl-2-imidazolidinone, 1-methyl-3-phenyl-2-imidazolidinone, 1,3-diphenyl-2-imidazolidinone, 1,3,4-trimethyl-2-imidazolidinone, 1,3-bis(trimethylsilyl)-2-imidazolidinone, 1,3-dihydro-1,3-dimethyl-2H-imidazol-2-one, tetrahydro-1,3-dimethyl-2(1H)-pyrimidinone, tetrahydro-1-methyl-3-phenyl-2(1H)-pyrimidinone, tetrahydro-1,3,5-trimethyl-2(1H)-pyrimidinone, tetrahydro-3,5-dimethyl-4H-1,3,5-oxadiazin-4-one, tetrahydro-1,3,5-trimethyl-1,3,5-triazin-2(1H)-one, hexahydro-1,3-dimethyl-2H-1,3-diazepin-2-one. A particularly preferred example is 1,3-dimethyl-2-imidazolidinone, also referred to as DMI, i.e. R₃ is —CH₂—CH₂— and/or R₁ and R₂ are both —CH₃.

Reagents according to formula (10) are described, for example, in U.S. Pat. No. 4,894,409, and international patent applications WO2021/009154 and WO2021/009156.

Functionalization agents according to formula (12) ((RO)ₓ(R)_{y}Si—R″—S—(R′) and (13),

(RO)ₓ(R)_{y}Si—R″—N(—R′)₂:

R represents independently an alkyl group, preferably from 1 to 12 carbon atoms, and R′ represents an alkyl group or an alkylsilyl group, preferably having from 1 to 12 carbon atoms and in case of two R's both R's can be connected to form a ring structure. In formula (12) and (13) x is 0, 1, 2 or 3 and y is 3-x and R″ is a spacer group, preferably comprising from 1 to 20 carbon atoms.

The coupling agent may also be used to provide functional groups, for example omega-functional groups. In that case no functionalization agent may be added after step (ii) but another functionalization reagent may be used, for example an alpha-functionalizing agent to create functional groups at the alpha-position of the polymer.

In case the polymerization reaction is not terminated by the reaction with the coupling reagent, or by the optional reaction with the one or more omega-functionalization agents described above, the polymerization reaction may be terminated, for example by quenching. Quenching agents known in the art may be used. Typical quenching agents for terminating the polymerization include alcohols, for example octanol.

The polymers may be worked up and isolated as known in the art. Antioxidants as known in the art, such as sterically hindered phenols, aromatic amines, phosphites, thioethers, may be added to the reaction mixture. Preferably they are added before or during the working up of the polymers of the present disclosure. Extender oils used for diene rubbers such as TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils can be added to the reaction mixture prior or during work up for providing oil-extended rubbers. The solvent can be removed from the reaction mixture by conventional methods including distillation, stripping with steam or by applying a vacuum or reduced pressure, if necessary, at elevated temperatures. Typically, the solvent is recycled. The polymer crumbs can be further dried on mills or processed on mills, for example into sheets, or compressed for example into bales.

### Alpha-Functionalization:

The functionalization reagents described above can react with reactive chain ends of the polymer and are therefore also referred to herein as “omega-functionalization reagents.” Instead of or in addition to adding the omega-functionalization reagents, “alpha-functionalization agents” may be added at the beginning of the polymerization, for example as functionalized initiators. This typically leads to alpha-functionalized polymers, i.e., polymers with polar groups at the beginning of the chain. Examples of alpha-functionalization reagents are described in EP 2847264 A1 and EP 2847242 A1. To prepare alpha-functionalized polymers the polymers may be prepared as described above except that one or more alpha-functionalization agent is used. The alpha-functionalization agent is used prior to step (ii), typically the functionalization reagent is used at the beginning of the polymerization reaction, i.e., at step (i), preferably at the beginning of step (i). Typically, alpha-functionalizing agents include aliphatic compounds comprising in addition to carbon and hydrogen atoms, heteroatoms selected from Si, O, S and N, and combinations thereof. Typical alpha-functionalizing agents have a molecular weight of up to 5,000 g/mol or less than 2,000 g/mol.

Alpha-functionalization agents include functional initiators carrying the functional group or a precursor thereof, for example a protected group that can be deprotected by hydrolyzation or otherwise, for example during work up or during compounding to make a rubber compound. Functional initiators include, for example, salts of organic anions of tertiary amines or cyclic amines where the nitrogen atom forms part of the aliphatic ring structure. An example of a tertiary amine containing functional initiator is represented by

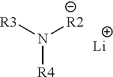

where R3 and R4 are the same or different and are organic residues having from 1 to 20 carbon atoms, preferably selected from linear or branched alkyls, silyl-substituted alkyls, and silyls, wherein R3 and R4 may be connected form a ring structure. R2 preferably is a linear or branched C1- to C20-alkyl or silyl-substituted alkyl group that carries a negative charge. Further examples include but are not limited to linear or cyclic amide initiators, for example salts of aliphatic amines having 4, 5, 6 or 7 carbon atoms and at least one nitrogen atom carries a negative charge. The ring may be unsubstituted or substituted once or more than once, preferably by a C1- to C20-alkyl substituent. Specific examples of cyclic amide initiators include, but are not limited to:

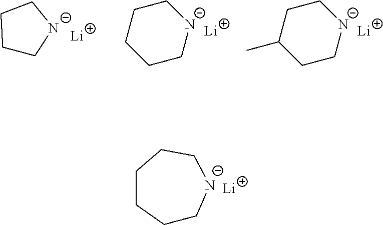

Functional initiators also include active reaction products of one or more initiator and one or more functionalized monomers. The functionalized monomer carries at least one functional group or a precursor thereof. The functionalized monomers may be used in equimolar amounts with respect to the initiator or in excess or the initiators may be used in molar excess compared to functionalized monomers. Examples of functionalized monomers include but are not limited to dienes, aliphatic and aromatic vinyls that are functionalized to carry one or more functional groups, for example trialkylamino groups, aminosilane groups, or alkoxy groups that can be hydrolyzed into hydroxy groups, or thioalkyl groups that can be hydrolyzed into thiol groups. Specific examples of functionalized aromatic vinyl compounds include but are not limited to trialkylaminostyrenes, for example those represented by (R₁)(R₂)N(R₃)ₓ-Ph-CH═CH₂ where x represents 1, 2, 3, 4 or 5, preferably 1, 2 or 3, and R₁, R₂, and R₃, preferably represent independently from each other a C1 to C20 alkyl group or alkylsilylgroups. R₁ and R₂ can be connected to form a ring. Further examples of functionalized aromatic vinyls include those represented by

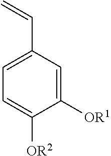

where R¹ and R² represent a functional group containing at least two selected from the group consisting of carbon, hydrogen, and silicon. Examples include hydrocarbon-based functional groups (functional groups containing carbon and hydrogen) such as methyl and ethyl groups which may be used as phenol-protecting groups, and silicon-based functional groups (functional groups containing carbon, hydrogen, and silicon) such as trimethylsilyl and triethoxysilyl groups. Preferred among these are hydrocarbon-based functional groups, preferably alkyl groups. The number of carbon atoms in the alkyl groups is preferably 1 to 6, more preferably 1 to 4, still more preferably 1 to 2. Preferably at least one of R¹ or R² is branched. Examples of recent publications concerning alpha-functionalization include US2021230416 A1 and EP3733718 A1.

Mixtures of different functionalized initiators or mixtures of functionalized and non-functionalized initiators may be used also.

Instead of using the functionalized monomers for making functionalised initiators they can also be used during the polymerization, for example during step (i), after step (i), before, during or after step (ii). They can be used in addition or as alternative to the functionalised initiator or other functionalizing agents. They may be used, for example, to provide an in-chain-functionalised polymer or to produce a polymer with sidechains carrying functional groups. Suitable functionalised monomers include aromatic monomer, for example amino-substituted styrenes and aliphatic monomers, for example vinylsilanes. They may be used during step (i), after step (i) and before, during or after step (ii) or a combination thereof. They may be added continuously or at intervals, for example to generate blocks of functionalized monomers units.

### Rubber Compounds

The polymers according to the present disclosure can be used to produce rubber compounds. Rubber compounds can be prepared by a process comprising mixing at least one polymer according to the present disclosure with at least one filler. The rubber compounds may be vulcanizable and further comprise one or more than one curing agent. The curing agent is capable of crosslinking (curing) the diene polymer and is also referred to herein as “crosslinker” or “vulcanization agent”. Suitable curing agents include, but are not limited to, sulfur, sulfur-based compounds, and organic or inorganic peroxides. In a preferred embodiment of the present disclosure the curing agent includes a sulfur. Instead of a single curing agent a combination of one or more curing agents may be used, or a combination of one or more curing agent with one or more curing accelerator or curing catalysts may be used. Examples of sulfur-containing compounds acting as sulfur-donors include but are not limited to sulfur, sulfur halides, dithiodimorpholine (DTDM), tetramethylthiuramdisulphide (TMTD), tetraethylthiuramdisulphide (TETD), and dipentamethylenthiuramtetrasulphide (DPTT). Examples of curing accelerators include but are not limited to amine derivates, guanidine derivates, aldehydeamine condensation products, thiazoles, thiuram sulphides, dithiocarbamates and thiophospahtes. In another embodiment of the present disclosure the curing agent includes a peroxide. Examples of peroxides used as vulcanizing agents include but are not limited to di-tert.-butyl-peroxides, di-(tert.-butyl-peroxy-trimethyl-cyclohexane), di-(tert.-butyl-peroxy-isopropyl-)benzene, dichloro-benzoylperoxide, dicumylperoxides, tert.-butyl-cumyl-peroxide, dimethyl-di(tert.-butyl-peroxy)hexane and dimethyl-di(tert.-butyl-peroxy)hexine and butyl-di(tert.-butyl-peroxy)valerate. A vulcanizing accelerator of sulfene amide-type, guanidine-type, or thiuram-type can be used together with a vulcanizing agent as required. If added, the vulcanizing agent is typically present in an amount of from 0.5 to 10 parts by weight, preferably of from 1 to 6 parts by weight per 100 parts by weight of rubber.

The rubber compounds are suitable for making tires or components of tires such as sidewalls or tire treads. The tire or tire component will typically contain the rubber compound in is vulcanized form.

Conventional fillers can be used. Conventional fillers include silicas and carbon-based fillers, for example carbon blacks. The fillers can be used alone or in a mixture. In a particularly preferred form, the rubber compositions contain a mixture of silica fillers and carbon black. The weight ratio of silica fillers to carbon black may be from 0.01:1 to 50:1, preferably from 0.05:1 to 20:1.

Preferably, the filler includes silica-containing particles, preferably having a BET surface area (nitrogen absorption) of from 5 to 1,000, preferably from 20 to 400 m²/g. Such fillers may be obtained, for example, by precipitation from solutions of silicates or by flame hydrolysis of silicon halides. Silica-containing filler particles may have particle sizes of 10 to 400 nm. The silica-containing filler may also contain oxides of Al, Mg, Ca, Ba, Zn, Zr or Ti. Other examples of silicon-oxide based fillers include aluminum silicates, alkaline earth metal silicates such as magnesium silicates or calcium silicates, preferably with BET surface areas of 20 to 400 m²/g and primary particle diameters of 10 to 400 nm,
natural silicates, such as kaolin and other naturally occurring silicates including clay (layered silicas). Further examples of fillers include glass particle-based fillers like glass beads, microspheres, glass fibers and glass fiber products (mats, strands).

Polar fillers, like silica-containing fillers, may be modified to make them more hydrophobic. Suitable modification agents include silanes or silane-based compounds. Typical examples of such modifying agents include, but are not limited to compounds corresponding to the general formula (7):

(R¹R²R³O)₃Si—R⁴—X (7)

wherein each R¹, R², R³ is, independently from each other, an alkyl group, preferably R¹, R², R³ are all methyl or all ethyl, R⁴ is an aliphatic or aromatic linking group with 1 to 20 carbon atoms and X is sulfur-containing functional group and is selected from —SH, —SCN, —C(═O)S or a polysulfide group.

Instead of or in addition to silicas that have been modified as described above such modification may also take place in situ, for example during compounding or during the process of making tires or components thereof, for example by adding modifiers, preferably silanes or silane-based modifiers, for example including those according to formula (7), when making the rubber compounds.

Filler based on metal oxides other than silicon oxides include but are not limited to zinc oxides, calcium oxides, magnesium oxides, aluminum oxides and combinations thereof. Other fillers include metal carbonates, such as magnesium carbonates, calcium carbonates, zinc carbonates and combinations thereof, metal hydroxides, e.g. aluminum hydroxide, magnesium hydroxide and combinations thereof, salts of alpha-beta-unsaturated fatty acids and acrylic or methacrylic acids having from 3 to 8 carbon atoms including zinc acrylates, zinc diacrylates, zinc methacrylates, zinc dimethacrylates and mixtures thereof.

In another embodiment of the present disclosure the rubber compound contains one or more fillers based on carbon, for example one or more carbon black. The carbon blacks may be produced, for example, by the lamp-black process, the furnace-black process or the gas-black process. Preferably, the carbon back has a BET surface area (nitrogen absorption) of 20 to 200 m²/g. Suitable examples include but are not limited to SAF, ISAF, HAF, FEF and GPF blacks.

Other examples of suitable filler include carbon-silica dual-phase filler, lignin or lignin-based materials, starch or starch-based materials and combinations thereof.

In a preferred embodiment, the filler comprises one or more silicon oxide, carbon black or a combination thereof.

Typical amounts of filler include from 5 to 200 parts per hundred parts of rubber, for example, from 10 to 150 parts by weight, or from 10 to 95 parts by weight for 100 parts by weight of rubber.

The rubber compounds may further contain one or more additional rubbers other than the diene rubbers according to the present disclosure and one or more than one rubber additive. Additional rubbers include, for example, natural rubber and synthetic rubber. If present, they may be used in amounts in the range from 0.5 to 95% by weight, preferably in the range from 10 to 80% by weight, based on the total amount of rubber in the composition. Examples of suitable synthetic rubbers include BR (polybutadiene), acrylic acid alkyl ester copolymers, IR (polyisoprene), E-SBR (styrene-butadiene copolymers produced by emulsion polymerization), S—SBR (styrene-butadiene copolymers produced by solution polymerization), IIR (isobutylene-isoprene copolymers), NBR (butadiene-acrylonitrile copolymers), HNBR (partially or completely hydrogenated NBR rubber), EPDM (ethylene-propylene-diene terpolymers) and mixtures thereof. Natural rubber, E-SBR and S-SBR with a glass temperature above −60° C., polybutadiene rubber with a high cis content (>90%) produced with catalysts based on Ni, Co, Ti or Nd, polybutadiene rubber with a vinyl content of up to 80% and mixtures thereof are of particular interest for the manufacture of automotive tires.

The rubber compounds may also comprise one or more rubber additive. Rubber additives are ingredients that may improve the processing properties of the rubber compositions, serve to crosslink the rubber compositions, improve the physical properties of the vulcanizates produced from the rubber, improve the interaction between the rubber and the filler or serve to bond the rubber to the filler. Rubber auxiliaries include, but are not limited to reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils as well as activators.

The total amount of rubber additives may range from 1 to 300 parts by weight, preferably from 5 to 150 parts by weight based on 100 parts by weight of total rubber in the composition.

The rubber compositions can be prepared with conventional processing equipment for making and processing of (vulcanizable) rubber compounds and include rollers, kneaders, internal mixers or mixing extruders. The rubber compositions can be produced in a single-stage or a multi-stage process, with 2 to 3 mixing stages being preferred. Cross-linking agents, for example sulfur, and accelerators may be added in a separate mixing stage, for example on a roller, with temperatures in the range of 30° C. to 90° C. being preferred. Cross-linking agent, for example sulfur, and accelerator are preferably added in the final mixing stage.

### Applications

The rubber compositions according to the present disclosure can be used for producing rubber vulcanizates, in particular for producing tires, in particular tire treads. Rubber vulcanizates can be obtained by providing a vulcanizable composition according to the present disclosure and subjecting it to at least one curing reaction. The vulcanizable and/or the vulcanized rubber composition can be subjected to shaping prior, during or after the curing reaction. Shaping may be carried out by process steps including molding, extruding and a combination thereof.

The (vulcanizable) rubber compositions provided herein are also suitable for the manufacture of molded articles, for example for the manufacture of cable sheaths, hoses, drive belts, conveyor belts, roll linings, shoe soles, sealing rings and damping elements.

Another aspect of the present disclosure relates to a molded article, in particular a component of a tire, for example a tire tread, or a complete tire, containing a vulcanized rubber composition obtained by vulcanizing a vulcanizable rubber composition according to the present disclosure.

The following examples are provided to further illustrate the present disclosure without, however, intending to limit the disclosure to the embodiments set forth in these examples.

### Examples

### Methods

The number-average molecular weight Mn, the weight average molecular weight, the dispersity [symbol] =Mw/Mn (also referred to herein as molecular weight distribution or MWD) and the degree of coupling of the polymers were determined using gel permeation chromatography (GPC) at 35° C. (THF as solvent and polystyrene calibration).

The Mooney viscosity was measured according to DIN ISO 289-1 (2018) at the measuring conditions ML(1+4) at 100° C. Mooney Stress Relaxation (MSR) was determined from the same measurement according to ASTM D 1646-00.

Dynamic properties of vulcanized compounds were determined according to DIN53513-1990 on Eplexor 500 N from Gabo-Testanlagen GmbH, Ahlden, Germany at 10 Hz in the temperature range from −100° C. to +100° C. at a heating rate of 1 K/min (Sample: strips with l*w*t=60 mm*10 mm*2 mm; free length between sample holder 30 mm). The following properties can be determined this way: tan δ (60° C.), i.e., the loss factor (E″/E′) at 60° C.; and tan δ (0° C.), i.e., the loss factor (E″/E′) at 0° C. tan δ (60° C.) is a measure of hysteresis loss from the tire under operating conditions. As tan δ (60° C.) decreases, the rolling resistance of the tire decreases. tan δ (0° C.) is a measure for the wet grip of the material. As tan δ (0° C.) increases the wet grip increases.

Elastic properties were determined according to DIN53513-1990. An elastomer test system (MTS Systems GmbH, 831 Elastomer Test System) was used. The measurements were carried out in double shear mode with no static pre-strain in shear direction and oscillation around 0 on cylindrical samples (two samples each 20×6 mm, pre-compressed to 5 mm thickness) and a measurement frequency of 10 Hz in the strain range from 0.1 to 40%. The method was used to obtain the following properties:
G′ (0.5%): dynamic modulus at 0.5% amplitude sweep, G′ (15%): dynamic modulus at 15% amplitude sweep, G′ (0.5%)-G′ (15%): difference of dynamic modulus at 0.5% relative to 15% amplitude sweep, tan δ (max): maximum loss factor (G″/G′) of entire measuring range at 60° C. The difference of G′ (0.5%)-G′ (15%) is an indication of the Payne effect of the mixture. The lower the value the better the distribution of the filler in the mixture, the better the rubber-filler interaction. Tan δ (max) is another measure of the hysteresis loss from the tire under operating conditions. As tan δ (max) decreases, the rolling resistance of the tire decreases.

The rebound elasticity was determined at 60° C. according to DIN 53512. An increase in rebound is an indication for decreasing rolling resistance.

### Polymers

### Example 1 (Comparative)

An inert 20 L reactor was filled with 8500 g hexane, 1500 g 1,3-butadiene and 10 mmol n-butyllithium (as a 23 wt. % solution in hexane) and stirred at 70° C. for 45 min. The polymer solution was quenched with 10 mmol n-octanol, stabilized with 4.5 g Irganox®1520 (2,4-bis(octylthiomethyl)-6-methylphenol), precipitated in ethanol and dried in a vacuum oven at 65° C. This reference example shows a general procedure for producing diene polymers. Copolymers of one or more conjugated dienes with one or more vinyl aromatic monomers, including styrenes can be prepared in the same way.

### Example 1a (Comparative)

An inert 20 L reactor was filled with 8500 g hexane, 1500 g 1,3-butadiene and 16 mmol n-butyllithium (as a 23 wt. % solution in hexane) and stirred at 70° C. for 45 min. 2.56 mmol SiCl₄ was added and stirred for 30 min. The polymer solution was quenched with 16 mmol n-octanol, stabilized with 7.5 g Irganox®1520 (2,4-bis(octylthiomethyl)-6-methylphenol). The solvent was removed by steam stripping and the polymer was dried in a vacuum oven at 65° C. The Mooney viscosity (ML(1+4)@100° C.) was measured to be 83 MU.

### Example 2 (Comparative)

An inert 20 L reactor was filled with 8500 g hexane, 1500 g 1,3-butadiene and 14.25 mmol n-butyllithium (as a 23 wt. % solution in hexane) and stirred at 70° C. for 45 min. 7.125 mmol 2.2-bis(2-tetrahydrofuryl)-propane was added to the living polymer solution and stirred for 5 min. 1.924 mmol SiCl₄ was added and stirred for 5 min. 8.55 mmol octamethylcyclotetrasiloxane was added and stirred for 15 min. 8.55 mmol 2,2-dimethyl-1-oxa-4-thia-2-silacyclohexan-6-one were added and stirred for 20 min. The solution was quenched with 14.25 mmol n-octanol and stabilized with 7.5 g Irganox®1520 (2,4-bis(octylthiomethyl)-6-methylphenol). 2 phr stearic acid was added. The solvent was removed by steam stripping. The polymer was dried in a vacuum oven at 65° C.

### Example 3 (Comparative)

Example 1 was repeated except that 16 mmol of n-BuLi was used and that after the reaction was stirred for 45 min 8 mmol of 1,3,5,7-tetravinyl-1,3,5,7-tetramethylcyclotetrasiloxane were added to the solution and the solution was stirred for another 20 min.

### Example 4

An inert 20 L reactor was filled with 8500 g hexane, 1500 g 1,3-butadiene and 16 mmol n-butyllithium (as a 23 wt. % solution in hexane) and stirred at 70° C. for 45 min. 8 mmol 1,3,5,7-tetravinyl-1,3,5,7-tetramethylcyclotetrasiloxane was added and stirred for 20 min. 8 mmol of 2,2-dimethyl-1-oxa-4-thia-2-silacyclohexan-6-one were added and stirred for another 20 min. The solution was quenched with 16 mmol n-octanol and stabilized with 7.5 g Irganox® 1520 (2,4-bis(octylthiomethyl)-6-methylphenol). The polymer was isolated as described above.

### Example 5

An inert 20 L reactor was filled with 8500 g hexane, 1500 g 1,3-butadiene and 15.7 mmol n-butyllithium (as a 23 wt. % solution in hexane) and stirred at 70° C. for 45 min. 15.7 mmol of 1,3,5,7-tetravinyl-1,3,5,7-tetramethylcyclotetrasiloxane were added to the polymer solution and the solution was stirred for 20 min. 15.7 mmol 2,2,4-trimethyl-1-oxa-4-aza-2-silacyclohexane were added and the reaction mixture was stirred for another 20 min. The polymer solution was quenched and stabilized, and the polymer was isolated as described above.

### Example 6

An inert 20 L reactor was filled with 8500 g hexane, 1500 g 1,3-butadiene and 14.25 mmol n-butyllithium (as a 23 wt. % solution in hexane) and stirred at 70° C. for 60 min. 7.125 mmol 2,2-bis(2-tetrahydrofuryl)-propane was added to the living polymer solution and stirred for 5 min. 14.25 mmol 1,3,5,7-tetravinyl-1,3,5,7-tetramethylcyclotetrasiloxane was added and stirred for min. 14.25 mmol 2,2-dimethyl-1-oxa-4-thia-2-silacyclohexan-6-one were added and the reaction mixture was stirred for another 20 min. The polymer solution was quenched with 14.25 mmol n-octanol and stabilized with 7.5 g Irganox®1520 (2,4-bis(octylthiomethyl)-6-methylphenol). 2 phr stearic acid were added before the solvent was removed by steam stripping and the polymer was dried in a vacuum oven at 65° C.

### Example 7

An inert 20 L reactor was filled with 8500 g hexane, 1500 g 1,3-butadiene and 15 mmol n-butyllithium (as a 23 wt. % solution in hexane) and stirred at 70° C. for 60 min. 7.5 mmol 2,2-bis(2-tetrahydrofuryl)-propane were added to the living polymer solution and the reaction mixture was stirred for 5 min. 0.525 mmol octavinyloctasilasesquioxane (POSS-Octavinyl substituted, from Sigma Aldrich) was added and the reaction mixture was stirred for 5 min. 11 mmol octamethylcyclotetrasiloxane was added and stirred for 15 min. 11 mmol 2,2-dimethyl-1-oxa-4-thia-2-silacyclohexan-6-one were added and the polymer solution was stirred for another 20 min. The polymer solution was quenched with 15 mmol n-octanol, stabilized with 7.5 g Irganox®1520 (2,4-bis(octylthiomethyl)-6-methylphenol). The work up was as in example 6.

### Example 8

An inert 20 L reactor was filled with 8500 g hexane, 1500 g 1,3-butadiene and 14.25 mmol n-butyllithium (as a 23 wt. % solution in hexane) and stirred at 70° C. for 60 min. 7.125 mmol 2,2-bis(2-tetrahydrofuryl)-propane was added to the living polymer solution and stirred for 5 min. 1.14 mmol 1,3,5,7-tetravinyl-1,3,5,7-tetramethylcyclotetrasiloxane was added and stirred for 5 min. 10.83 mmol octamethylcyclotetrasiloxane was added and stirred for 15 min. 10.83 mmol 2,2-dimethyl-1-oxa-4-thia-2-silacyclohexan-6-one were added and the reaction mixture was stirred for another 20 min. The polymer solution was quenched with 14.25 mmol n-octanol and stabilized with 7.5 g Irganox®1520 (2,4-bis(octylthiomethyl)-6-methylphenol). 2 phr stearic acid were added before the solvent was removed by steam stripping and the polymer was dried in a vacuum oven at 65° C.

TABLE 1
Properties of the polymers obtained in examples 1 to 8 (*= comparative)

| Examples | 1 * | 2* | 3* | 4 | 5 | 6 | 7 | 8 |
|---|---|---|---|---|---|---|---|---|
| Mₙ/kg mol⁻¹ | 361 | 389 | 406 | 396 | 337 | 299 | 384 | 319 |
| Ð | 1.17 | 1.51 | 1.44 | 1.49 | 1.46 | 1.48 | 1.88 | 1.56 |
| Degree of | — | 56 | 80 | 80 | 64 | 55 | 53 | 43 |
| coupling/% | | | | | | | | |
| ML1 + 4@100° C./ | 62 | 69 | 82 | 82 | 56 | 56 | 62 | 43 |
| MU | | | | | | | | |
| MSR | 1.293 | 0.673 | 0.635 | 0.692 | 0.761 | 0.816 | 0.694 | 0.723 |

Examples 3 to 8 demonstrate that unsaturated siloxanes can be used to prepare coupled polymers. Coupling is demonstrated by the coupling degrees and low MSR values. Polymers prepared with unsaturated siloxanes according to the present disclosure can be reacted with different functionalization reagents as demonstrated by examples 4 to 8.

### Compound Studies

It is known that diene rubbers that are functionalized with polar functional group can improve the dispersion of fillers in tire compounds. In tire compounds rubbers and fillers are the major components and better dispersion of filler in the rubber matrix can ultimately lead to improved tire properties. Rubber compounds containing functionalized diene rubbers are typically more challenging to process than their unfunctionalized counterparts. It was found that the polymers obtained with the unsaturated siloxane-based coupling agents according to the present disclosure may also be used for making tire components and may even lead to compounds having improved filler interactions.

### Examples 9-16

Rubber compositions (examples 9-16) comprising diene rubbers obtained in examples 1, 1A, 2, 3, 6, 7 and 8 were prepared in a 1.5 L kneader with the ingredients shown in table 3 using the mixing protocol shown in table 2. The resulting compositions were vulcanized at 160° C. for min. The properties of the vulcanizates are summarized in tables 3 and 3A.

TABLE 2
Mixing protocol.

| | | |
|---|---|---|
| Step 1: Mixing in a 1.5 L | 0 s | Addition of polymers |
| kneader | 30 s | Addition of ⅔ silica, ⅔ silane, stabilizers, |
| | | stearic acid |
| | 90 s | Addition of ⅓ silica, ⅓ silane, oil, CB |
| | 150 s | Addition of ZnO |
| | 210 s | Heat up to 150° C. and hold for 3 min |

| | |
|---|---|
| Step 2: Mill | 3 × r/l cross-cutting and folding, 3 × end roll (4 mm) |
| Step 3: Storage | 24 h |
| Step 4: Mixing in a 1.5 L | Heat up to 150° C. and hold at temperature for 3 min |
| kneader | |
| Step 5: Mill | 3 × r/l cross-cutting and folding (4 mm) |
| | Sulfur, accelerators |
| | 3 × r/l cross-cutting and folding, 5 × end roll (4 mm) |

TABLE 3
Compound recipes and test results

| | CEx 9 | CEx 10 | Ex 11 | Ex 12 | Ex 13 |
|---|---|---|---|---|---|
| Polymer of Ex 1 | 38 | | | | |
| Polymer of Ex 2 | | 38 | | | |
| Polymer of Ex 6 | | | 38 | | |
| Polymer of Ex 7 | | | | 38 | |
| Polymer of Ex 8 | | | | | 38 |
| Non-functionalized styrene- | 85.25 | 85.25 | 85.25 | 85.25 | 85.25 |
| butadiene polymer (VSL 4526- | | | | | |
| 2HM from ARLANXEO | | | | | |
| Deutschland GmbH) | | | | | |
| ULTRASIL 7000 GR (silica) | 90 | 90 | 90 | 90 | 90 |
| N375 (carbon black) | 5 | 5 | 5 | 5 | 5 |
| VIVATEC 500 | 7.75 | 7.75 | 7.75 | 7.75 | 7.75 |
| AFLUX 37 | 3 | 3 | 3 | 3 | 3 |
| VULKANOX 4020/LG | 2 | 2 | 2 | 2 | 2 |
| VULKANOX HS/LG | 2 | 2 | 2 | 2 | 2 |
| ANTILUX 654 | 2 | 2 | 2 | 2 | 2 |
| SI 69 | 7.2 | 7.2 | 7.2 | 7.2 | 7.2 |
| SULPHUR 90/95 | 1.7 | 1.7 | 1.7 | 1.7 | 1.7 |
| RHENOGRAN ZnO-80 | 3.75 | 3.75 | 3.75 | 3.75 | 3.75 |
| EDENEOR C 18 98-100 | 1 | 1 | 1 | 1 | 1 |
| RHENOGRAN DPG-80 | 2.5 | 2.5 | 2.5 | 2.5 | 2.5 |
| RHENOGRAN TBBS-80 | 2 | 2 | 2 | 2 | 2 |
| Compound Mooney viscosity* | 100 | 113 | 121 | 114 | 120 |
| Rebound at 60° C. * | 100 | 104 | 111 | 106 | 107 |
| tan δ maximum (MTS amplitude | 100 | 106 | 110 | 112 | 109 |
| sweep, 1 Hz, 60° C.)* | | | | | |
| G′ (0.5%) − G′ (15%) * | 100 | 130 | 143 | 160 | 151 |
| tan δ at 0° C. (Eplexor, 10 Hz) * | 100 | 94 | 99 | 101 | 94 |
| tan δ at 60° C. (Eplexor, 10 Hz) * | 100 | 105 | 108 | 107 | 108 |

* The test results in table 3 are shown as index values relative to the value obtained for reference example 9 (made with reference polymer 1). A higher index value means the respective property has improved over the reference example. The index values for compound Mooney viscosity, tan δ maximum and tan δ at 60° C. were calculated as: [(value obtained for reference example 9)/(value of example)] × 100. The index values for rebound at 60° C. and tan δ at 0° C. were calculated as [(value of example)/(value obtained for reference example 9)] × 100.; EX = example, CEx = comparative example.

The results show that polymers obtained with unsaturated siloxanes according to the invention (examples 11-13) had an improved compound Mooney viscosity compared to reference polymers 1 and 2 (comparative example 9 and 10), which indicates better processability. Examples 11 to 13 had excellent filler dispersion as indicated by an improved Payne effect index (lower [G′(0.5%)-G′(15%)]) and improved rolling resistance indicators (rebound 60° C., tan δ maximum and tan delta at 60° C.) compared to the reference polymers. The wet grip performance (tan δ at 0° C.) was similar to that of the reference polymers.

### Example 14 (Comparative)

A functionalized styrene-butadiene polymer was prepared without using a coupling reagent according to the present disclosure by anionic polymerization in hexane using BuLi as initiator. The living polymer was treated first with OMTS and then with SL in equimolar amounts. The reaction was terminated by adding octanol and IRGANOX 1520. The polymer was obtained by steam-stripping and drying at 60° C. under reduced pressure.

### Example 15

A coupled and functionalized polymer was prepared by anionic polymerization in hexane using 9.55 mmol BuLi as initiator. The living polymer was treated with a coupling agent according to the present disclosure by adding 1.19 mmol 1,3,5,7-tetravinyl-1,3,5,7-tetramethylcyclotetrasiloxane. The temperature of the reaction mixture was 60° C. and the mixture was reacted for 10 min at 60° C. The coupled polymer was functionalized by treating the reaction mixture with 9.55 mmol 2,2-dimethyl-[1,4,2]oxathiasilinan-6-one and letting the reacting proceed for 10 min at 60° C. The reaction was terminated, and the polymer was isolated as described above.

### Example 16

A coupled and functionalized polymer was prepared by first creating a reactive initiator mixture. A moisture-free, nitrogen-flushed 20 L reactor was charged with 8500 g hexane, 1.70 g N,N-dimethylaminomethylstyrene and 5.43 mmol DTHFP, heated to 35° C. and reacted with 10.56 mmol BuLi for 20 min to form a reactive initiator solution. Anionic polymerization was carried out by adding a mixture of 1185 g butadiene and 315 g styrene and reacting it for 60 min (T Max 58.4° C.). 1.32 mmol 1,3,5,7-tetravinyl-1,3,5,7-tetramethylcyclotetrasiloxane were added to the living polymer solution and reacted for 10 min at 60° C. 10.56 mmol 2,2-dimethyl-[1,4,2]oxathiasilinan-6-one were added and reacted for 10 min at 60° C. The reaction was terminated and worked up as described above.

The polymers from examples 14 to 16 were compounded using the mixing protocol of table 2 and the ingredients of table 3, except that 70 phr of the polymers, 30 phr of NdBR (trade designation CB24) were used. ZEOSIL 1165 MP was used instead of ULTRASIL 7000 GR. The polymer properties are shown in tables 4 and 5.

TABLE 4
Characterization of the polymers obtained in examples 14 to 16.

| Example | Mₙ/kg mol⁻¹ | PDI | MV | Tg/° C. | styrene/% wt |
|---|---|---|---|---|---|
| 14 (comparative) | 250 | 2.8 | 70 | −27 | 21 |
| 15 | 390 | 1.8 | 104 | −23 | 21 |
| 16 | 330 | 2.0 | 98 | −23 | 21 |

MV = ML1 + 4@100° C./MU; PDI = Mw/Mn

TABLE 5
Properties of compounds made with
polymers from examples 14 to 16.

| | CEx14 | Ex15 | Ex16 |
|---|---|---|---|
| Compound Mooney viscosity | 73 | 74 | 80 |
| Rebound at 60° C. | 58 | 57 | 59 |
| tan δ maximum* | 0.177 | 0.176 | 0.167 |
| G′ (0.5%) − G′ (15%) | 1.97 | 1.74 | 1.88 |
| tan δ at 0° C. (Eplexor, 10 Hz) | 0.253 | 0.275 | 0.273 |
| tan δ at 60° C. (Eplexor, 10 Hz) | 0.98 | 0.96 | 0.95 |

*MTS amplitude sweep, 1 Hz, 60° C.

The results shown in table 5 demonstrate that coupling with a coupling agent according to the present disclosure also improves the properties of styrene-butadiene copolymers. The decrease of G′(0,5%)-G′(15%) values indicates improved rubber-filler interaction. Rolling resistance indicators (rebound and tan delta at 60° C.) remained similar. Wet grip properties improved indicated by an increased tan delta at 0° C.

The polymers of examples 14 to 16 were extruded through a Garvey die (at 70° C. and 50 rpm). The profiles obtained with comparative polymer 14 were rough but the profiles obtained with polymers from examples 15 and 16 were smooth.

### Example 17 (Comparative)

A functionalized styrene-butadiene that was coupled by a coupling agent not according to the present disclosure was prepared by anionic polymerization in hexane with BuLi as initiator. Octamethylcyclotetrasiloxane and tetrachlorosilane were added to the living polymer and reacted for 10 min at 70° C. 2,2-dimethyl-[1,4,2]oxathiasilinan-6-one were added an reacted for 30 min. The reaction was terminated and worked up as described above.

### Example 18

A styrene-butadiene copolymer was prepared by anionic polymerization in hexane with BuLi as initiator. 3.5 mmol 1,3,5,7-tetravinyl-1,3,5,7-tetramethylcyclotetrasiloxane were added to the living polymer and reacted for 10 min at 70° C. 14 mmol 2,2-dimethyl-[1,4,2]oxathiasilinan-6-one were added and reacted for 10 min at 70° C. The reaction was terminated and worked up as described above.

### Example 19

A styrene-butadiene copolymer was prepared as in example 18 except that 15 mmol glutaric acid anhydride were used as modifying agent.

The polymers from examples 17 to 19 were compounded using the mixing protocol shown in table 2 and the ingredients shown in table 3. The properties are shown in table 6 and 7:

TABLE 6
Properties of the polymers obtained in examples 17 to 19:

| Example | Mₙ/kg mol⁻¹ | PDI | MV | Tg/° C. | styrene/% wt |
|---|---|---|---|---|---|
| 17 (comparative) | 341 | 1.6 | 92 | −59 | 11 |
| 18 | 370 | 1.6 | 78 | −60 | 11 |
| 19 | 419 | 1.7 | 81 | −59 | 10 |

MV = ML1 + 4@100° C./MU; PDI = Mw/Mn

TABLE 5
Properties of compounds made with
the polymers of examples 17 to 19

| | CEx 17 | Ex 18 | Ex19 |
|---|---|---|---|
| Compound Mooney viscosity | 97 | 67 | 94 |
| Rebound at 60° C. | 59 | 62 | 63 |
| tan δ maximum* | 0.176 | 0.164 | 0.170 |
| G′ (0.5%) − G′ (15%) | 2.08 | 1.77 | 1.49 |
| tan δ at 0° C. (Eplexor, 10 Hz) | 0.162 | 0.177 | 0.190 |
| tan δ at 60° C. (Eplexor, 10 Hz) | 0.098 | 0.087 | 0.091 |

*(MTS amplitude sweep, 1 Hz, 60° C.)

A comparison of examples 18 and 19 with comparative example 17 demonstrates an improvement independent of the type of end groups.

### Example 20 (Comparative)

A styrene-butadiene copolymer was prepared using a coupling agent according to the present disclosure but without a functionalization agent. The polymer was prepared using 15 mmol BuLi as initiator. 1.6 mmol octavinyl octasilasesquioxane were added to the living polymer and reacted for 30 min at 60° C. The reaction was terminated and worked up as described above.

### Example 21

Example 20 was repeated. After the octavinyl octasilasesquioxane was added and reacted for 30 min at 60° C. 8 mmol 2,2-dimethyl-[1,4,2]oxathiasilinan-6-one were added and reacted for 10 min at 60° C. The reaction was terminated and worked up as described above.

The polymers from examples 20 and 21 were compounded (mixing protocol of table 2 and ingredients of table 3 except that the polymers were used in amounts of 70 phr together with an NdBR (CB24) at 30 phr). The properties are shown in tables 8 and 9.

TABLE 8
Characterization of the polymers obtained in examples 20 and 21:

| Example | Mₙ/kg mol⁻¹ | PDI | MV | Tg/° C. | styrene/% wt |
|---|---|---|---|---|---|
| 20 (comparative) | 309 | 2.1 | 52 | −23 | 21 |
| 21 | 289 | 3.0 | 54 | −24 | 21 |

MV = ML1 + 4@100° C./MU; PDI = Mw/Mn

TABLE 9
Properties of compounds made with
the polymers of examples 20 and 21:

| | CEx 20 | Ex 21 |
|---|---|---|
| Compound Mooney viscosity | 47 | 47 |
| Rebound at 60° C. | 53 | 59 |
| tan δ maximum* | 0.198 | 0.192 |
| G′ (0.5%) − G′ (15%) | 2.11 | 1.83 |
| tan δ at 0° C. (Eplexor, 10 Hz) | 0.242 | 0.266 |
| tan δ at 60° C. (Eplexor, 10 Hz) | 0.116 | 0.103 |

*(MTS amplitude sweep, 1 Hz, 60° C.)

The results shown in table 9 demonstrate the positive effects of functionalizing polymers that have been coupled with a different unsaturated siloxane agent (comparative example 20 versus example 21). The decrease of G′(0,5%)-G′(15%) values indicates improved rubber-filler interaction. Rolling resistance indicators (rebound and tan delta at 60° C.) improved as shown by an increase in rebound and decrease of tan delta at 60° C. Wet grip properties improved indicated by an increased tan delta at 0° C.

The polymers of examples 20 and 21 were extruded through a Garvey die (at 70° C. and 50 rpm) and gave both smooth profiles.

### Example 22

A moisture-free, nitrogen-flushed 20 L reactor was charged with 8500 g hexane, 7.44 mmol hexamethyleneimine, 7.44 mmol pyrrolidine and 6.4 mmol DTHFP, heated to 33.5° C. and reacted with 18.6 mmol BuLi for 30 min to form a reactive initiator solution. A mixture of 1185 g butadiene and 315 g styrene was added and polymerized under adiabatic conditions for 60 min (T Max 60.2° C.). 2.33 mmol 1,3,5,7-tetravinyl-1,3,5,7-tetramethylcyclotetrasiloxane were added to the living polymer solution and reacted for 10 min at 60° C. 18.6 mmol 3-(diethylamino)propyltrimethoxysilane were added and reacted for 10 min at 60° C. The reaction was worked as described above.

### Example 23

The polymer was prepared as in example 22 except that 18.6 mmol tert.-butyl-[3-[dimethoxy(methyl)silyl]propylsulfanyl]-dimethylsilane was added instead of 2,2-dimethyl-[1,4,2]oxathiasilinan-6-one.

Polymers of examples 22 and 23 were compounded and compared to comparative example 14. The compounding was carried out as described in tables 2 and 3 except that 70 phr of the polymers and 30 phr of NdBR (trade designation CB24) were used. The polymer data are shown in table 10 and compound data in table 11.

TABLE 10
polymer data of polymers from examples 22 and 23

| | EX22 | EX23 |
|---|---|---|
| Mₙ/kg mol⁻¹ | 350 | 313 |
| Ð | 1.96 | 2.24 |
| ML1 + 4@100° C./MU | 87 | 89 |
| Vinyl/wt. % | 51.1 | 51.2 |
| Styrene/wt. % | 20.7 | 20.5 |
| T_{g}/° C. | −23.3 | −21.2 |

TABLE 11
compound data

| | CEx14 | EX22 | EX23 |
|---|---|---|---|
| Increase in Mooney viscosity*/MU | 20 | 8 | 9 |
| Rebound at 60° C. | 100 | 118 | 111 |
| tan delta maximum (MTS amplitude sweep at 1 Hz, 60° C.) | 100 | 111 | 102 |
| tan delta at 0° C. (Eplexor, 10 Hz) | 100 | 118 | 116 |
| tan delta at 60° C. (Eplexor, 10 Hz) | 100 | 118 | 111 |
| S300 | 100 | 110 | 109 |

The test results in table 11 are shown as index values relative to the value obtained for the reference example. A higher index value means the respective property has improved over the reference example. The index values for tan δ maximum and tan δ at 60° C. were calculated as: [(value obtained for reference example)/(value of example)]×100. The index values for rebound at 60° C., tan δ at 0° C. and S300 were calculated as [(value of example)/(value obtained for reference example)]×100;
The Mooney viscosity increase is calculated as: ML(1+4)@100° C. (compound)−ML(1+4)@100° C. (polymer). A lower value indicates a better processability.

The value for did not change for example 21 compared to the reference und for example 22 it deteriorated (not shown in table 11) and the Garvey profiles were the same as the reference. However. but rolling resistance and wet grip indicators improved in polymers compared to the reference.

1. Method of making a polydiene rubber comprising
(i) polymerizing at least one aliphatic conjugated diene monomer,-preferably having from 4 to 25 carbon atoms, to produce a polymer having reactive polymer chain ends,
(ii) reacting at least some of the reactive polymer chain ends with a coupling agent comprising from 2 to 20 unsaturated siloxane units or from 3 to 10 units,
(iii) using at least one functionalization agent for introducing at least one functional group to the polymer, wherein the functional group, preferably, has in addition to C and H atoms at least one heteroatom selected from Si, S, N, O or combinations thereof and wherein (iii) is carried out before, after or during step (ii).

2. The method according to claim 1, wherein the unsaturated siloxane unit comprises at least one alkenyl group selected from the group consisting of vinyl, allyl, n-butenyl, isobutenyl, n-pentenyl, isopentenyl, or a combination thereof.

3. The method according to claim 1, wherein the unsaturated siloxane unit of the coupling agent corresponds to formula (1), 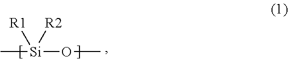
wherein R1 represents an alkenyl and wherein each R2 independently represents H, OH or an organic residue.

4. The method according to claim 3, wherein each R2 independently represents H, OH, an alkenyl having from 2 to 10 carbon atoms, an alkyl having from 1 to 10 carbon atoms, wherein the alkyl or alkenyl chain or both may be interrupted once or more than once by an ether oxygen atom, or a siloxane or polysiloxane with up to 10 silicon atoms wherein the siloxane or polysiloxane, optionally, has at least one silicone atom having at least one aliphatic substituent selected from alkyl or alkenyl groups or a combination thereof, and at least one R2 is methyl, or all residues R2 are either methyl or ethyl or a combination thereof.

5. The method of claim 1, wherein the unsaturated siloxane unit of the coupling agent corresponds to the formula (2): 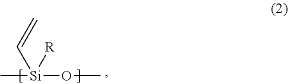
wherein each R independently represents H, OH or an organic residue having from 1 to 20 carbon atoms and, optionally, one or more heteroatom selected from O, N, Si, S and a combination thereof,

6. The method of claim 4, wherein R represents H, OH, an alkenyl having from 2 to 10 carbon atoms, an alkyl having from 1 to 10 carbon atoms, wherein the alkyl or alkenyl chain or both may be interrupted once or more than once by an ether oxygen atom, or a siloxane or polysiloxane with up to 10 silicon atoms wherein the siloxane or polysiloxane, optionally, has at least one silicone atom having at least one aliphatic substituent selected from alkyl or alkenyl groups or a combination thereof, or at least one R is methyl, or all residues R are either methyl or ethyl or a combination thereof.

7. The method according to claim 1, wherein the coupling agent has at least one cyclic structure comprising at least three of the unsaturated siloxane units.

8. The method according to claim 1, wherein the coupling agent corresponds to formula (3) 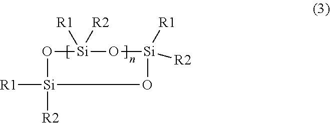
wherein n is an integer of 1 to 5, or 1 to 3, R1 is alkenyl and each R2 independently represents H, OH or an organic residue having from 1 to 20 carbon atoms and, optionally, one or more heteroatom selected from O, N, Si, S and a combination thereof, or R1 is vinyl and each R2 is selected independently from a C₁-C₇-alkyl or from methyl.

9. The method of claim 1 wherein the coupling agent corresponds to formula (4): 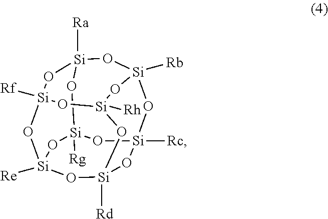
wherein Ra, Rb, Rc, Rd, Re, Rf, Rg and Rh are identical or different from each and are selected independently from each other from a C₁-C₁₀-alkyl group, a C₂-C₆-alkenyl group or a —O—Si—(R_{1′}R_{2′}R_{3′}) group, wherein R1′, R2′ and R3′ are selected independently from each other from a C₁-C₁₀-alkyl group or a C₂-C₆-alkenyl group and at least one of R1′, R2′ and R3′ is a vinyl group unit, and wherein the coupling agent comprises at least 2, or at least 3 C₂-C₆-alkenyl group, or all of Ra—Rh are vinyl.

10. The method according to claim 1, wherein the coupling agent has a molecular weight of less than 5000 g/mol, or less than 2000 g/mol.

11. The method according to claim 1, wherein the conjugated diene monomer is 1,3 butadiene.

12. The method according to claim 1, wherein step (i) comprises copolymerizing one or more copolymerizable vinylaromatic comonomers.

13. The method according to claim 1, wherein the method comprises adding a functionalization agent after step (i) and before, during or after step (ii) or a combination thereof and wherein the functionalization agent comprises at least one group selected from anhydrides, carbamides, (R)₃Si—N—; (R₃)Si—; (R)₃Si—S—; (R)₂Si(—O—)- or combinations thereof, wherein each R represents, independently, an alkyl or alkoxy, having from 1 to 12 carbon atoms, or 1 to 6 carbon atoms, wherein two residues R may be linked with each other to form a ring structure.

14. The method according to claim 1, wherein the method comprises using an alpha-functionalization agent at step (i) or a functionalized comonomer at step (i), (ii) or after step (iii), or the method comprising using at least one functionalized comonomer and at least one alpha-functionalizing agent.

15. A polydiene rubber obtained by the method according to claim 1.

16. A curable composition comprising the polydiene rubber obtained by the method according to claim 1 and further comprising at least one vulcanisation agent for curing the polydiene rubber, optionally comprising the vulcanisation agent in an amount of from 0.5 to 10 parts by weight per 100 parts by weight of diene rubber.

17. A composition comprising a cured polydiene rubber obtained by curing the curable composition obtained by the method according to claim 1.

18. The method according to claim 3 wherein R1 represents an alkenyl selected from the group consisting of vinyl, allyl, n-butenyl, isobutenyl, n-pentenyl, isopentenyl and wherein each R2 independently represents H, OH or an organic residue having from 1 to 20 carbon atoms and, optionally, one or more heteroatom selected from O, N, Si, S and a combination thereof.

19. The method according to claim 3 wherein each R2 independently represents H, OH, an alkenyl having from 2 to 10 carbon atoms, an alkyl having from 1 to 10 carbon atoms, wherein the alkyl or alkenyl chain or both may be interrupted once or more than once by an ether oxygen atom, or a siloxane or polysiloxane with up to 10 silicon atoms wherein the siloxane or polysiloxane, optionally, has at least one silicone atom having at least one aliphatic substituent selected from alkyl or alkenyl groups or a combination thereof, and at least one R2 is methyl, or all residues R2 are either methyl or ethyl or a combination thereof.

20. A composition comprising a cured polydiene rubber obtained by curing the curable composition obtained by the method according to claim 1, wherein the composition is an article selected from a tire or a tire tread.
